(19) United States
(12) Patent Application Publication
(10) Pub. No.: US 2013/0158780 A1
(43) Pub. Date: Jun. 20, 2013

(54) IN-VEHICLE ELECTRONIC APPARATUS AND DIAGNOSTIC SYSTEM

(71) Applicant: DENSO CORPORATION, Kariya-city (JP)

(72) Inventors: Takeo UMESAKA, Obu-city (JP); Mikio TERAMURA, Okazaki-city (JP)

(73) Assignee: DENSO CORPORATION, Kariya-city (JP)

(21) Appl. No.: 13/719,601

(22) Filed: Dec. 19, 2012

(30) Foreign Application Priority Data
Dec. 19, 2011 (JP) 2011-277412

(51) Int. Cl. G06F 17/00

(52) U.S. Cl. CPC G06F 17/00
USPC 701/33.4; 701/1

(57) ABSTRACT

When any one of multiple driving informational parameters has shown a predetermined change in a determination process, an in-vehicle electronic apparatus sets 1 to a change history provided per each driving informational parameter. When the change history of any one of the driving informational parameters is 1 in the storage process, the in-vehicle electronic apparatus determines that any one of the driving informational parameters has shown the predetermined change between the previous process and current process. Then, the in-vehicle electronic apparatus stores a current time as a change time in a corresponding area provided in an RAM to the driving informational parameter that has shown the predetermined change and sets the change history to 0. When the predetermined vehicle behavior occurs, the in-vehicle electronic apparatus stores, in an SRAM or EEPROM, the change time stored in the RAM and an occurrence time when the predetermined vehicle behavior occurs.

### CROSS REFERENCE TO RELATED APPLICATION

The present application is based on Japanese Patent Application No. 2011-277412 filed on Dec. 19, 2011, the disclosure of which is incorporated herein by reference.

### TECHNICAL FIELD

The present disclosure relates to an in-vehicle electronic apparatus that stores analysis information to analyze causes of predetermined vehicle behaviors.

### BACKGROUND ART

Patent document 1: U.S. Pat. No. 5,754,965 B

Patent Document 1 discloses an art of diagnosing vehicle behaviors from abnormal values of detection signals of various sensors mounted to a vehicle. A well known art is for storing output information of various sensors before and after a collision etc. as driving information of a vehicle when the vehicle is impacted by the collision.

When an abnormality occurs in a sensor or an actuator, (i) a diagnosis code corresponding to the abnormal state and the sensor outputs and (ii) control data in chronological order in the abnormal state are stored as driving information (freeze frame data).

Additionally, a vehicle behavior not corresponding to a driver's manipulation may occur although (i) a vehicle is not impacted, (ii) an output value of a sensor is normal, and (iii) the sensor, an actuator, etc. are normal. Such a case may require analysis of a cause of this occurrence.

Then, the following analysis has been proposed. Driving information is stored at fixed time intervals. When a predetermined vehicle behavior has occurred, a cause of the predetermined vehicle behavior is analyzed on the basis of the stored driving information.

However, when a change period in which the driving information changes is short, a detection signal showing the driving information may be set from off to on and then from on to off in a fixed time interval of detecting the driving information, for example. In this case, a change of the driving information is undetectable. Even when the change of this driving information is a cause of the predetermined vehicle behavior, it is difficult to store this change. As a result, the cause of the predetermined vehicle behavior cannot be appropriately analyzed.

Further, multiple pieces of driving information may be provided from multiple different sensors or sources. The driving information may be referred to as a driving informational parameter. Even when multiple driving informational parameters change apart within a predetermined period, these changes are detected only at the same timeframe at every predetermined time intervals. Therefore, the order of the changes of the driving informational parameters cannot be specified. Thus, even when a time from a predetermined change of the driving informational parameter to occurrence of the predetermined vehicle behavior or the order of changes of the driving informational parameters is a criterion to analyze a cause of the predetermined vehicle behavior, this analysis of the cause is insufficient.

However, in the structure to detect and store the driving informational parameters at predetermined intervals, when a time interval to store the driving informational parameters is shortened, data of a change of the driving informational parameter that changes in a short period or the order of predetermined changes of the driving informational parameters can be detected and stored. However, when the time interval for the storage is shortened, the storage amount increases.

### SUMMARY

For addressing the above disadvantage, it is an object of the present disclosure to provide an in-vehicle electronic apparatus and a diagnostic system that store appropriate driving information having minimum storage amounts to analyze causes of predetermined vehicle behaviors.

To achieve the above object, according to an example of the present disclosure, an in-vehicle electronic apparatus is provided to store analysis information to analyze causes of predetermined vehicle behaviors. The apparatus includes a change determination section, a behavior determination section, and a storage section. The change determination section determines whether multiple driving informational parameters showing driving states of a vehicle indicate predetermined changes respectively. The behavior determination section determines whether a predetermined vehicle behavior occurs. The storage section stores, in a storage portion as analysis information, (i) an occurrence time of the predetermined vehicle behavior determined to occur by the behavior determination section, as well as (ii) a change time of the driving informational parameter determined to indicate the predetermined change by the change determination section by (i.e., at and before) the occurrence time of the predetermined vehicle behavior. Herein, the occurrence time of the predetermined vehicle behavior is a time when the behavior determination section determines that the predetermined vehicle behavior occurs; the change time of the driving informational parameter is a time when the change determination section determines that a subject driving informational parameter indicates a predetermined change.

In this structure, changes of the driving informational parameters are focused; a change time at which the driving informational parameter has shown the predetermined change is stored as analysis information. Thus, change times of the driving informational parameters that have shown the predetermined changes can be stored completely to specify the driving informational parameter that has shown the predetermined change. The driving informational parameters whose change times have not been stored can be determined to have shown no predetermined changes.

Thus, this structure may obtain a change state of the driving informational parameter up to the occurrence time when the predetermined vehicle behavior occurs based on (i) the presence or absence of the predetermined change of the driving informational parameter which can be determined based on whether its change time has been stored, and (ii) the change time of the driving informational parameter that has shown the predetermined change. As a result, a cause of the predetermined vehicle behavior can be analyzed.

The driving informational parameters whose change times have not been stored have not shown the predetermined changes. Thus, these driving informational parameters can be removed from analysis targets of causes of the predetermined vehicle behaviors. Thereby, the analysis time can be reduced.

Further, since the driving informational parameters that have shown the predetermined changes can be arranged chronologically based on the stored change times. Accordingly, when the order of the driving informational parameters that have shown the predetermined changes affects causes of the predetermined vehicle behaviors, the causes of the predetermined vehicle behaviors can be analyzed based on the changed order.

Suppose a case that a single change time is stored with respect to each of the multiple driving informational parameters that have shown the predetermined changes. Even in such a case, the simultaneously stored multiple change times with respect to the multiple driving informational parameters naturally indicate their chronological orders among the multiple change times themselves, respectively. Accordingly, a storage amount of the analysis information can be reduced in comparison with that in the structure in which the driving informational parameters are stored at every time intervals as the analysis information.

According to another example of the present disclosure, a diagnostic system is provided to include the in-vehicle electronic apparatus according to the above example and a diagnostic tool connected to the in-vehicle electronic apparatus. The tool includes: a read section to read analysis information stored in the storage portion of the in-vehicle electronic apparatus; and an output section to output the analysis information read from the storage portion.

According to this structure, based on the analysis information including the change times and occurrence time outputted from the diagnostic tool, a cause of the predetermined vehicle behavior can be easily analyzed.

### BRIEF DESCRIPTION OF THE DRAWINGS

The above and other objects, features, and advantages of the present disclosure will become more apparent from the following detailed description made with reference to the accompanying drawings. In the drawings:

FIG. 1 is a block diagram showing a diagnostic system of an embodiment of the present disclosure;

FIG. 2A is a time chart showing changes of driving informational parameters;

FIG. 2B is a list of change times;

FIG. 3A is another time chart showing changes of the driving informational parameters;

FIG. 3B is a list of change times;

FIG. 4A is another time chart showing changes of the driving informational parameters;

FIG. 4B is a list of change times;

FIG. 5A is another time chart showing changes of driving informational parameters;

FIG. 5B is a list of change times;

FIG. 6A is a flowchart showing a determination process to determine changes of driving informational parameters;

FIG. 6B is a flowchart showing a storage process to store a change time when a driving informational parameter has shown a predetermined change;

FIG. 7A is a flowchart showing another determination process;

FIG. 7B is a flowchart showing an interrupt process to store change times;

FIG. 7C is a flowchart showing another storage process;

FIG. 8 is a flowchart showing another interrupt process to store change times;

FIG. 9 is a flowchart showing a storage process to further store a driving informational parameter at an occurrence time of a behavior;

FIG. 10A is a flowchart showing a determination process before a behavior;

FIG. 10B is a flowchart showing a determination process after a behavior;

FIG. 11 is a flowchart showing a storage process to store change times before and after a behavior;

FIG. 12 is a flowchart showing a storage process to store a change time when a driving informational parameter has shown a predetermined change and a driving informational parameter related to the changed driving informational parameter;

FIG. 13 is a flowchart showing an output process of a diagnostic tool;

FIG. 14A is a flowchart showing another output process of the diagnostic tool; and

FIG. 14B is a list of change times rearranged.

### DETAILED DESCRIPTION

Hereafter, an embodiment of the present disclosure is described based on the appended drawings.

(Diagnostic System)

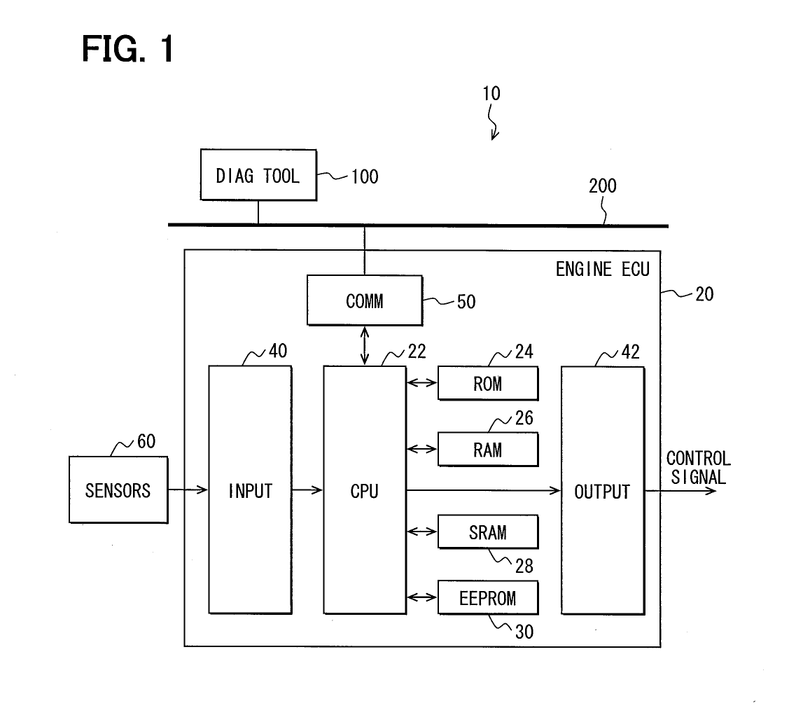

FIG. 1 shows a diagnostic system 10 for a subject vehicle according to the present embodiment. The diagnostic system 10 includes an engine ECU (hereinafter, just an ECU) 20 and a diagnostic tool 100.

The ECU (Electronic Control Unit) 20 includes a CPU 22, a ROM 24, an RAM 26, an SRAM (Standby RAM) 28, an EEPROM 30, an input circuit 40, an output circuit 42, and a communication circuit 50.

The CPU 22 executes a control program stored in the ROM 24, and thereby the ECU 20 inputs detection signals such as an accelerator opening, an engine speed, an intake amount, an intake temperature, a water temperature, and ON and OFF of an ignition from various sensors 60 via the input circuit 40. Based on these detection signals, the ECU 20 outputs control signals of, for example, fuel injection of an injector (not shown) and ignition of a spark plug (not shown) via the output circuit 42.

Unlike the RAM 26 ready for execution of the control program of the ECU 20 and losing its own stored data at interruption of a power supply when an ignition switch is turned off to stop a drive of the vehicle, the SRAM 28 is supplied power from a battery even when a drive of the vehicle stops. Therefore, data stored in the SRAM 28 is stored unless an electric power supply is interrupted, e.g., at replacement of a battery.

The EEPROM 30 is a rewritable non-volatile storage portion or media. Even when a drive of the vehicle stops, data stored in the EEPROM 30 is held.

The communication circuit 50 communicates with other ECUs mounted in a vehicle via a communication line 200 by an in-vehicle LAN, such as CAN (Controller Area Network), and transmits data stored in the SRAM 28 or EEPROM 30 to the diagnostic tool 100 via the communication line 200.

The diagnostic tool 100 is structured mainly by a microcomputer including a CPU, a ROM, an RAM, etc. The diagnostic tool 100 is connected to the communication line 200. The diagnostic tool 100 reads, from the ECU 20, a change time at which the after-mentioned driving informational parameter has shown the predetermined change. When a driving informational parameter (i.e., a value of a driving informational parameter) at occurrence or occurrence time of a predetermined vehicle behavior is stored, the diagnostic tool 100 reads this informational parameter from the ECU 20. Then, the diagnostic tool 100 outputs the read change time and the read informational parameter to a display etc.

It is noted that the driving informational parameter may be also referred to as driving information. Further, while some languages such as English use “information” primarily as being an uncountable noun, Basic Japanese Patent Application, which the present application claims the priority based on, uses a Japanese word equivalent to “information” primarily as being a countable noun from the nature of Japanese language. The present application may therefore use “information” as being a countable noun as well as an uncountable noun. That is, “an information” may read “a piece of information,” “an informational parameter,” “an informational item,” “an informational record” or the like whereas “a plurality of informations” may read “a plurality of pieces of information,” “a plurality of informational parameters,” “a plurality of informational items,” “a plurality of informational records,” or the like. Further, in order to explicitly indicate either singular or plural, the present application uses “driving informational parameter” as an English translation of the Japanese word equivalent to “driving information.”

Next, each section, device, or means to make the ECU 20 function when the CPU 22 executes a control program stored in the ROM 24 etc. is explained.

(Change Determination Section)

The ECU 20 includes a change determination section, device, or means to determine whether multiple driving informational parameters showing driving states of the vehicle have shown predetermined changes. The predetermined changes are shown by: digital data after an AD-conversion when inputted data is analog data; and a change of a data value across a predetermined value or an excess of a change amount of the data value over a predetermined amount when ternary or more data (i.e., multiple-valued digital data more than binary data) is inputted. Determination conditions for data values of the driving informational parameters are shown in the following (1) to (4).

(1) When a previous data value is over a threshold and a current data value is under the threshold, or the previous data value is under the threshold and the current data value is over the threshold.

(2) Only when the previous data value is over the threshold and the current data value is under the threshold.

(3) Only when the previous data value is under the threshold and the current data value is over the threshold.

(4) When a change amount of the data value between the previous data value and the current data value exceeds a predetermined amount.

In the determination condition (1), the ECU 20 determines that a driving informational parameter shows a predetermined change when the data value changes toward either side across the threshold. On the other hand, in the determination conditions (2) and (3), the ECU 20 determines that the driving informational parameter shows the predetermined change when the data value changes only from one side to the other side across the threshold.

In the determination condition (4), the ECU 20 determines that the driving informational parameter shows the predetermined change when an absolute value of the current data value minus the previous data value is over a predetermined amount. Thus, by obtaining a difference between the current data value and the previous data value, noise can be canceled and thus reduced when the noise is injected into the data value. Thereby, even when noise is injected into the data value of the driving informational parameter, it can be determined whether the driving informational parameter has shown the predetermined change accurately.

In the determination condition (4), a change amount per a unit time may be calculated from the absolute value of the current data minus the precious data value and compared to the predetermined amount.

In case of binary digital data, one of the following determination conditions (1) to (4) is set to determine whether a driving informational parameter has shown a predetermined change. When the determination condition is satisfied, the driving informational parameter is determined to have shown the predetermined change.

(1) When a data value is on at the previous time and off at the current time, or off at the previous time and on at the current time.

(2) Only when the data value is on at the previous time and off at the current time.

(3) Only when the data value is off at the previous time and on at the current time.

(4) In (1) to (3), when the data value is the same at current time as at the previous time after on and off are switched between the previous-previous time and previous time.

In the determination condition (1) for binary digital data, the ECU 20 determines that the driving informational parameter has shown the predetermined change when a value of on is switched to a value of off or a value of off is switched to a value of on. On the other hand, in the determination conditions (2) and (3), the ECU 20 determines that the driving informational parameter has shown the predetermined change only when a value of on or off switches only in one direction.

In the determination condition 4, a data value is determined once more after the data value switches from on or off to the other. Therefore, even when the driving informational parameter is determined to have shown the predetermined change by erroneously determining the data value to be on or off due to noise, the driving informational parameter can be determined to have shown no predetermined change unless a value after the change becomes the same value one more time. The data value may be determined twice or more.

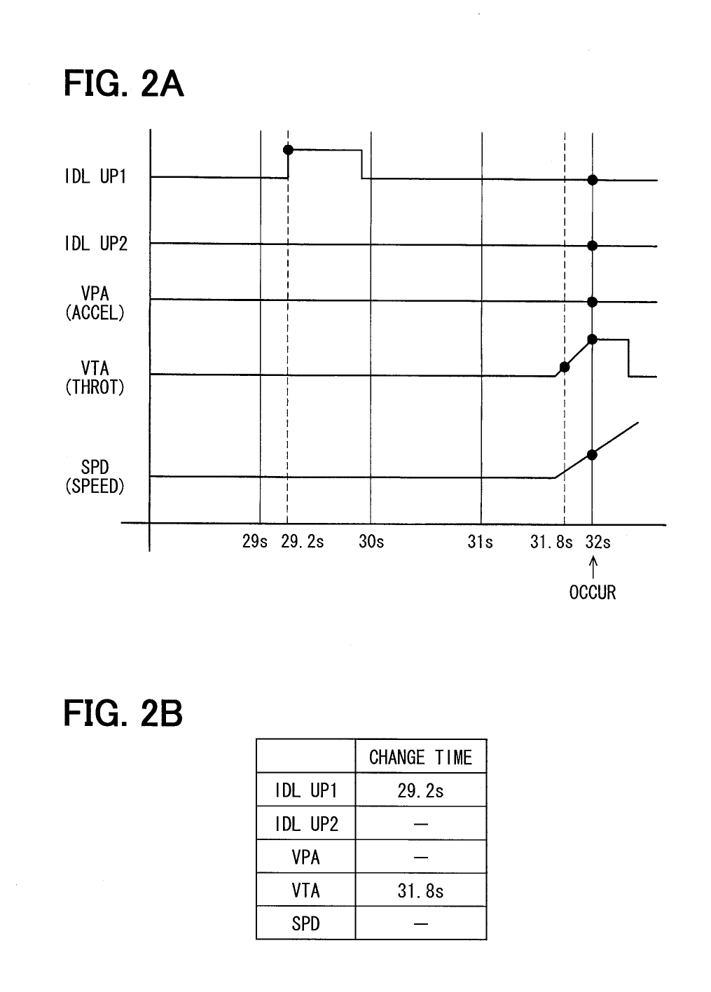

As shown in FIGS. 2A, 2B, 3A, 3B, 4A, 4B, 5A, and 5B, the driving informational parameters to be determined include an IDL-UP (IDLUP) 1, an IDL-UP 2, an acceleration opening, a throttle opening, a vehicle speed, an engine speed, an injection instruction signal, an ignition signal for a spark plug, etc. The IDL-UP 1 and IDL-UP 2 are signals of factors such as an air conditioner, a defroster for windows, lights, and a brake that may require an engine speed to rise at idle driving.

Analog data such as the acceleration opening and throttle opening are inputted without change and AD-converted in the ECU 20, or AD-converted to digital data outside the ECU 20 and then inputted to the ECU 20.

(Storage Section)

The ECU 20 includes a storage section, device, or means to temporarily store, in the RAM 26 as analysis information to analyze a cause of a predetermined vehicle behavior, a change time at which (i.e., when) a driving informational parameter shows a predetermined change. Herein, the analysis information may be also referred to as an analysis informational record. The RAM 26 has areas to store change times for every driving informational parameters whose changes are to be determined.

When the predetermined vehicle behavior occurs, the ECU 20 or storage section stores the change time, which is stored in the RAM 26, in the SRAM 28 or EEPROM 30. The SRAM 28 or EEPROM 30 has areas to store change times for every driving informational parameters whose changes are to be determined.

In addition to a change time before the predetermined vehicle behavior, the ECU 20 or storage section may further store, in the SRAM 28 or EEPROM 30, (i) a driving informational parameter related to the driving informational parameter that has shown a predetermined change at a change time, (ii) a driving informational parameter when a predetermined vehicle behavior occurs (i.e., at an occurrence time of the predetermined vehicle behavior), and (iii) a change time after the predetermined vehicle behavior. It is noted, a driving informational parameter related to the driving informational parameter that has shown a predetermined change at a change time may signify a value of the driving informational parameter; a driving informational parameter at an occurrence time of the predetermined vehicle behavior may signify a value of the driving informational parameter.

The driving informational parameters stored at occurrences of predetermined vehicle behaviors include an accelerator opening, an engine speed, a throttle opening, a gear shift position of a transmission, an intake amount, an intake temperature, a water temperature, a vehicle speed, etc., in addition to the driving informational parameters shown in FIGS. 2A, 2B, 3A, 3B, 4A, 4B, 5A, and 5B.

When an in-vehicle camera and a navigation system are mounted, a driving state of a different vehicle around a user's vehicle or subject vehicle on the basis of analysis of image data taken by the in-vehicle camera, a shape of a road such as a curvature and a slope on the basis of map data, and the like may be stored as the driving informational parameters in the subject vehicle, in addition to the driving informational parameters showing drive states of the subject vehicle.

The change time may be indicated by use of trips each of which is from a power-on to start driving a vehicle to a power-off to stop driving the vehicle on the basis of what order a current trip is and a relative time elapsed from a start of each trip or on the basis of an absolute time of year-month-day-hour-minute-second. Each of the times shown in FIGS. 2A, 2B, 3A, 3B, 4A, 4B, 5A, and 5B shows a relative time from a start of a trip, and is temporarily set for explanation.

In this embodiment, when a driving informational parameter is stored at an occurrence time of a predetermined vehicle behavior, the latest driving informational parameter is overwritten to the previous driving informational parameter and stored even when the predetermined vehicle behavior occurs multiple times on a time axis. When the storage capacity has a margin, the driving informational parameter may be stored each time the predetermined vehicle behavior occurs.

(Behavior Determination Section)

The ECU 20 includes a behavior determination section, device, or means to set predetermined vehicle behaviors as shown in the following (1) to (3) in advance to thereby determine whether a predetermined vehicle behavior has occurred based on detection signals of various sensors.

Vehicle behaviors of (1) and (2) do not correspond to manipulations of a driver, and are abnormal actions unexpected by the driver. A vehicle behavior of (3) occurs, e.g., at rapid depression of an accelerator and does not occur in normal drive manipulations.

(1) Although an accelerator pedal is not depressed, a throttle opening opens larger than a predetermined opening. The predetermined opening (behavior determination opening) at this time is set larger than a predetermined opening (change determination opening) used to determine whether a throttle opening has shown a predetermined change.

(2) Although an ignition key is not turned off, an engine speed falls to around zero.

(3) Regardless of detection values of the other sensors, the throttle opening opens over a predetermined opening (upper limit opening) that is slightly under the maximum of the change range assumed to change by normal driving manipulations. For example, when the accelerator pedal is depressed to open the throttle opening over the upper limit opening, the predetermined vehicle behavior is determined to have occurred. The upper limit opening of the throttle opening is set larger than the change determination opening.

(Cause of Behavior)

In FIG. 2A, the ECU 20 determines that the IDLE-UP 1 has shown the predetermined change when the IDLE-UP 1 is turned on from off at 29.2 s, and when the throttle opening becomes larger than the change determination opening at 31.8 s, the ECU 20 determines that the throttle opening has shown the predetermined change to store 29.2 s and 31.8 s as change times, as shown in FIG. 2B.

Since the ECU 20 determines that the IDL-UP 1 has shown the predetermined change when the IDL UP1 is turned on from off, the ECU 20 determines that the IDL-UP 1 has been turned on from off even when a period of the on-state of the IDL-UP 1 is short. Thus, the change time at which IDL-UP 1 is turned on from off can be stored.

In FIG. 2, the throttle opening exceeds the change determination opening at 31.8 s after the IDL UP1 is turned on from off at 29.2 s, the throttle opening exceeds the behavior determination opening at 32 s without depression of the accelerator, and the vehicle speed increases and the vehicle accelerates. Now, this unusual behavior is defined as a behavior causing the vehicle to accelerate without depression of the accelerator by a driver and not corresponding to the manipulation of the driver. As a result, analysis has shown that a cause of the unusual behavior is that the IDL UP1 is turned on from off.

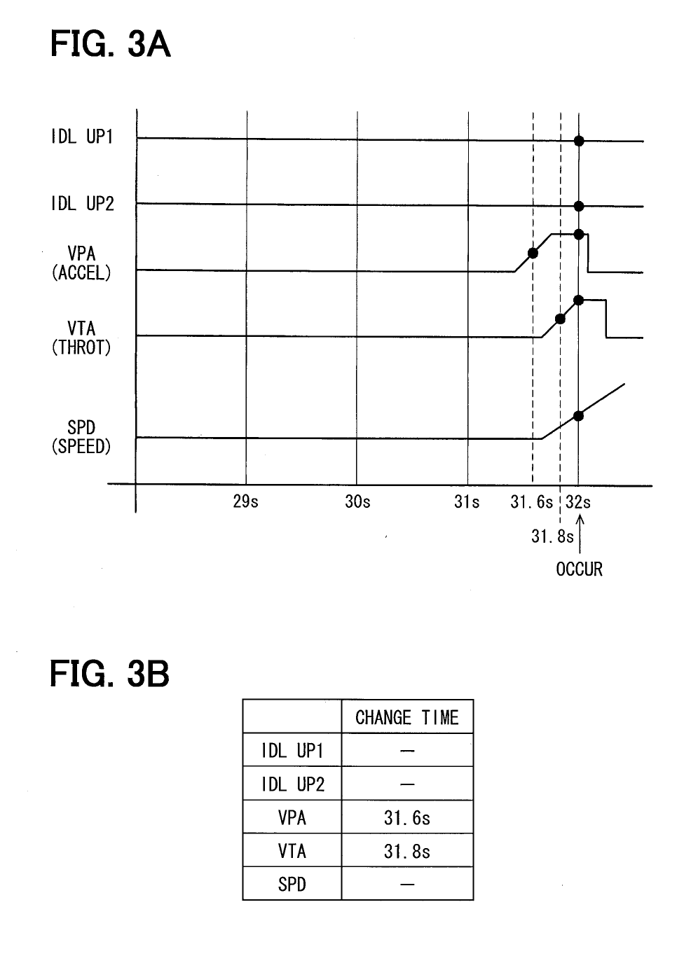

In FIG. 3A, the ECU 20 determines that the accelerator opening has shown the predetermined change when the accelerator opening has exceeded a predetermined opening or angle at 31.6 s, and determines that the throttle opening has shown the predetermined change when the throttle opening exceeds the change determination opening at 31.8 s. Then, the ECU 20 stores 31.6 s and 31.8 s as change times, as shown in FIG. 3B.

At 32 s, the predetermined vehicle behavior in which the throttle opening becomes larger than the maximum opening occurs, and then the ECU 20 determines that the vehicle has accelerated. Since the change time of the accelerator opening is earlier than the change time of the throttle opening in the example of FIGS. 3A, 3B, analysis has shown that the predetermined vehicle behavior in which the throttle opening becomes larger than the maximum opening is caused by a manipulation of the accelerator by the driver.

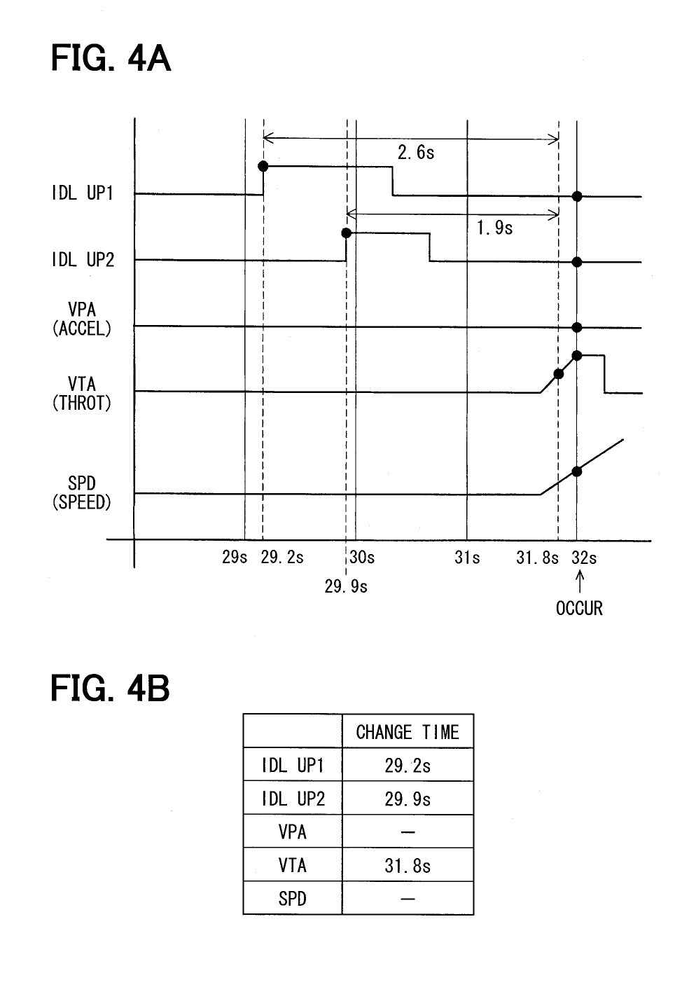

In FIG. 4A, the ECU 20 determines that the IDL UP1 has shown the predetermined change when the IDL UP1 is turned on from off at 29.2 s, determines that the IDL UP2 has shown the predetermined change when the IDL UP2 is turned on from off at 29.9 s, and determines that the throttle opening has shown the predetermined change when the throttle opening exceeds the change determination opening at 31.8 s. Then, the ECU 20 stores 29.2 s, 29.9 s, and 31.8 s as change times, as shown in FIG. 4B.

The ECU 20 determines that the predetermined vehicle behavior in which the throttle opening becomes larger than the behavior determination opening without depression of the accelerator has occurred at 32 s and the vehicle has accelerated. In FIG. 4A, response times after the IDL UP1 and IDL UP2 are turned on from off until the throttle opening exceeds the change determination opening are 2.6 s and 1.9 s, respectively.

In vehicle control, when appropriate response times after the IDL UP1 and IDL UP2 are turned on from off until the throttle opening exceeds the change determination opening are about 2 s respectively, the response time (2.6 s) of the throttle opening after the IDL UP1 changes until the throttle opening exceeds the change determination opening can be determined to be inappropriate, and the response time (1.9 s) of the throttle opening after the IDL UP2 changes until the throttle opening exceeds the change determination opening can be determined to be appropriate. Therefore, analysis has shown that a cause of excess of the throttle opening over the maximum opening is that the IDL UP1 is turned on from off.

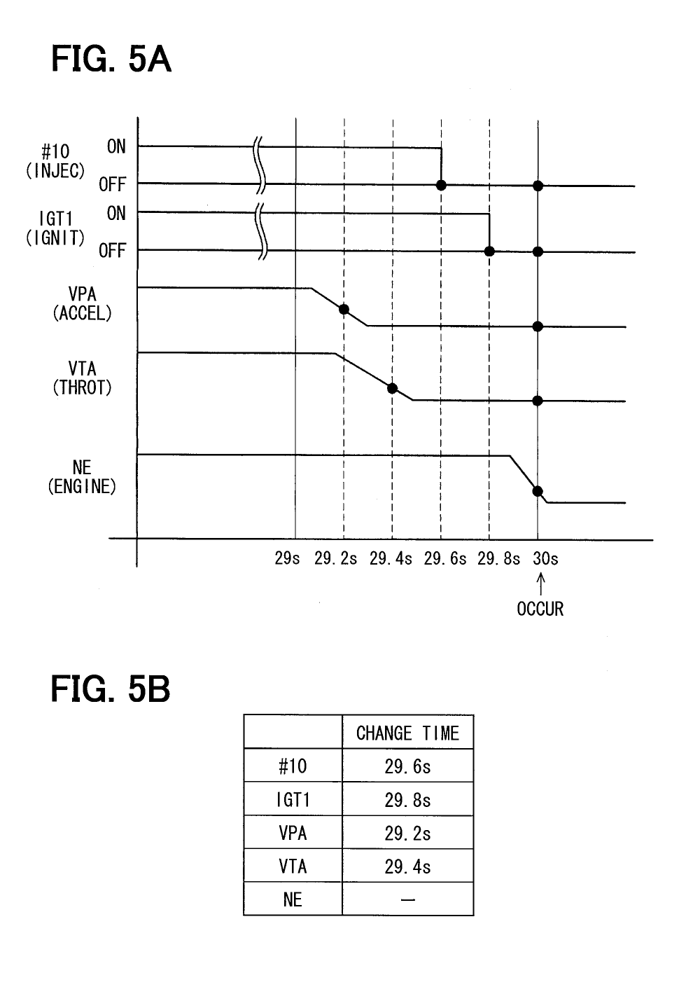

By storing change times of the driving informational parameters, a response time of the vehicle behavior is determined after the driving informational parameter has shown the predetermined change to analyze a cause of the predetermined vehicle behavior. In FIG. 5A, the determinations of the ECU 20 are follows. The ECU 20 determines that the accelerator opening has shown the predetermined change when the accelerator opening decreases below the predetermined opening at 29.2 s. The ECU 20 determines that the throttle opening has shown the predetermined change when the throttle opening decreases below the change determination opening at 29.4 s. The ECU 20 determines that an injection command signal has shown the predetermined change when the injection command signal is turned off from on at 29.6 s. The ECU 20 determines that an ignition signal has shown the predetermined change when the ignition signal is turned off from on at 29.8 s. As shown in FIG. 5B, the ECU 20 stores 29.2 s, 29.4 s, 29.6 s, and 29.8 s as change times.

At 30 s, the ECU 20 determines that the predetermined vehicle behavior has occurred when the engine speed decreases to around zero without turning off the ignition key. In FIG. 5A, since the throttle opening decreases after the accelerator opening decreases, analysis has shown that the decrease of the accelerator opening is caused by the engine shutdown.

(Determination Process 1 and Storage Process 1)

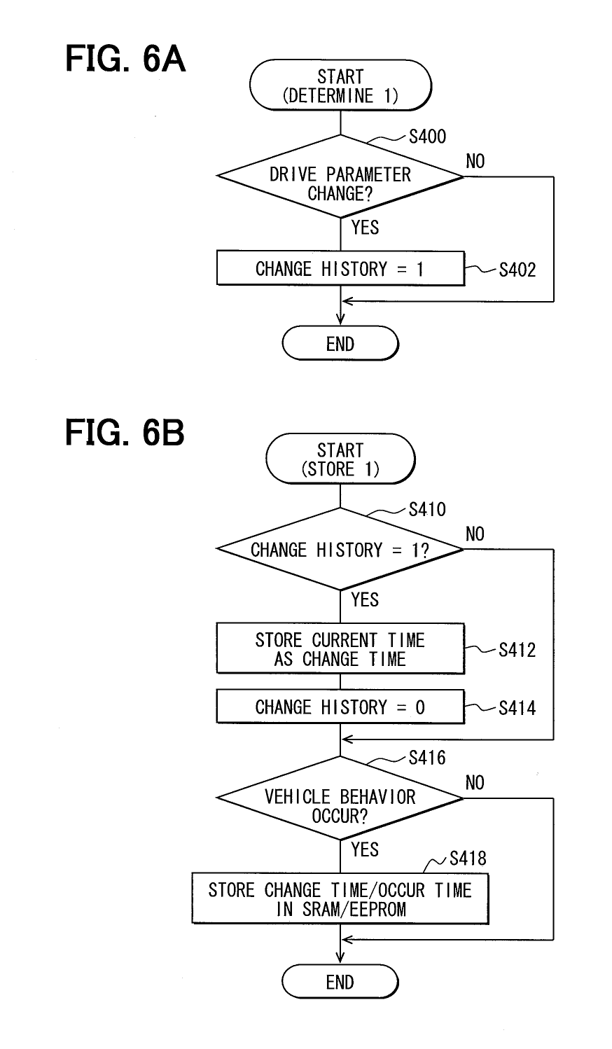

FIG. 6A is a flowchart of a determination process 1 to determine whether the driving informational parameter has shown the predetermined change. FIG. 6B is a flowchart of the storage process 1 to store a change time when the driving informational parameter has shown the predetermined change.

It is noted that a flowchart or the processing of the flowchart in the present application includes sections (also referred to as steps), each of which is represented, for instance, as S400. Further, each section can be divided into several sections while several sections can be combined into a single section. Furthermore, each of thus configured sections can be also referred to as a device or means.

Each or any combination of sections explained in the above can be achieved as (i) a software section in combination with a hardware unit (e.g., computer) or (ii) a hardware section, including or not including a function of a related apparatus; furthermore, the hardware section may be constructed inside of a microcomputer.

Furthermore, the software section may be included in a software program, which may be contained in a non-transitory computer-readable storage media as a program product.

In FIGS. 6A, 6B, 7A, 7B, 7C, 8, 9, 10A, 10B, 11, 12, 13, 14A, and 14B, the determination process is executed every one ms, which is a shorter time interval than that in a usual control. The storage process is executed at the same time interval of 65 ms as the usual control.

In FIG. 6A, the ECU 20 determines whether any one of multiple driving informational parameters has shown the predetermined change (S400). The changes of the driving informational parameters are determined by determining whether to satisfy the determination conditions of the change determination section explained above.

When any one of the driving informational parameters has shown the predetermined change (S400: Yes), the ECU 20 sets 1 to a corresponding one of change histories to the driving informational parameter that has shown the predetermined change (S402) as a variable showing whether the driving informational parameter has shown the predetermined change. The change histories are provided to respective driving informational parameters in the RAM 26. When the change history is 1, the corresponding driving informational parameter has shown the predetermined change. An initial value of the change history is 0.

In FIG. 6B, the ECU 20 determines whether the change history of any one of the driving informational parameters is 1 (S410). When the change history is not 1 (S410: No), the ECU 20 determines that the driving informational parameter has not changed between the previous storage process and the current storage process, and the flow proceeds to S416.

When the change history is 1 (S410: Yes), the ECU 20 determines that any one of the driving informational parameters has shown the predetermined change between the previous storage process and the current storage process. Then, the ECU 20 stores a current time as a change time in a corresponding one of storage areas to the driving informational parameter that has shown the predetermined change (S412), the storage areas being provided to respective driving informational parameters in the RAM 26. The ECU 20 sets the change history from 1 to 0 (S414).

One change time is set to each driving informational parameter in the storage area of the RAM 26. Therefore, each time the driving informational parameter shows the predetermined change, overwriting with a newest change time is executed and the newest change time is stored in the RAM 26. An initial value of the change time is 0. Therefore, when the change time is 0, the driving informational parameter can be determined to have shown no predetermined change.

In the storage process shown in FIG. 6B, the current time stored as the change time is not the actual time at which the driving informational parameter has shown the predetermined change, but is delayed for 65 ms at most. A cause of the predetermined vehicle behavior can be analyzed appropriately regardless of the delay.

The ECU 20 determines whether the predetermined vehicle behavior has occurred at S416. Then, when the predetermined vehicle behavior occurs (S416: Yes), the ECU 20 stores, in the SRAM 28 or EEPROM 30, (i) the change time stored in the RAM 26 and (ii) an occurrence time of the predetermined vehicle behavior, simultaneously (S418). When the driving informational parameter has shown no predetermined change, an initial value of the change time is stored in the SRAM 28 or EEPROM 30.

In the determination process 1 shown in FIG. 6A, it is determined whether the driving informational parameter has shown the predetermined change at a shorter time interval than a usual control process. Therefore, the change is detectable even when a period of this change of the driving informational parameter is short.

Based on a determination result of the determination process 1, the change time at which the driving informational parameter has shown the predetermined change is stored temporarily in the RAM 26. The change time stored in the RAM 26 when the predetermined vehicle behavior has occurred is stored in the SRAM 28 or EEPROM 30 that stores storage data even when drive of the vehicle stops.

Therefore, when the change times stored in the SRAM 28 or EEPROM 30 are read by a dealer etc., the driving informational parameters that have shown the predetermined changes and the driving informational parameters that have shown no predetermined change can be specified to obtain the temporal context or time-basis order of changes of the driving informational parameters that have shown the predetermined changes. As a result, a cause of the predetermined vehicle behavior can be analyzed appropriately.

Even when only one change time is stored for each driving informational parameter that has shown the predetermined change, the temporal context or time-basis order of the driving informational parameters that have shown the predetermined changes can be obtained from the respective change times. A storage amount of analysis information can be reduced in comparison with that in the structure of storing the driving informational parameters every predetermined time intervals as the analysis information.

In the determination process 1 of FIG. 6A and the storage process 1 of FIG. 6B, since only the change times of the driving informational parameters that have shown the predetermined changes are stored as analysis information, a storage amount of the analysis information can be reduced.

Since the determination process 1 and storage process 1 are executed by different programs respectively, a total processing time of one determination process 1 and one storage process 1 is shorter than that of executing these processes by the same program. As shown in FIG. 6, even when a time interval to execute the determination process 1 is made short or set to 1 ms, the determination process 1 does not greatly affect the overall process load. The time interval to execute the determination process 1 is made short or set to 1 ms as shown in FIG. 6 to detect changes of the driving informational parameters accurately.

In the determination process 1 of FIG. 6A and storage process 1 of FIG. 6B, the process of S400 may correspond to the function executed by the change determination section, device, or means of the ECU 20 or CPU 22, the processes of S412 and S418 may correspond to the function executed by the storage section, device, or means of the ECU 20 or CPU 22, and the process of S416 may correspond to the function executed by the behavior determination section, device, or means of the ECU 20 or CPU 22.

The change times and occurrence time stored at the processes of S412 and S418 may correspond to analysis information.

The ECU 20 corresponds to an in-vehicle electronic apparatus of the present disclosure, and may function as the change determination section, device, or means, the storage section, device, or means, and the behavior determination section, device, or means of the ECU 20 or CPU 22. The RAM 26 to store change times temporarily and the SRAM 28 or EEPROM 30 to store the change times at occurrences of the predetermined vehicle behaviors may correspond to a storage portion or media.

(Determination Process 2 and Storage Process 2)

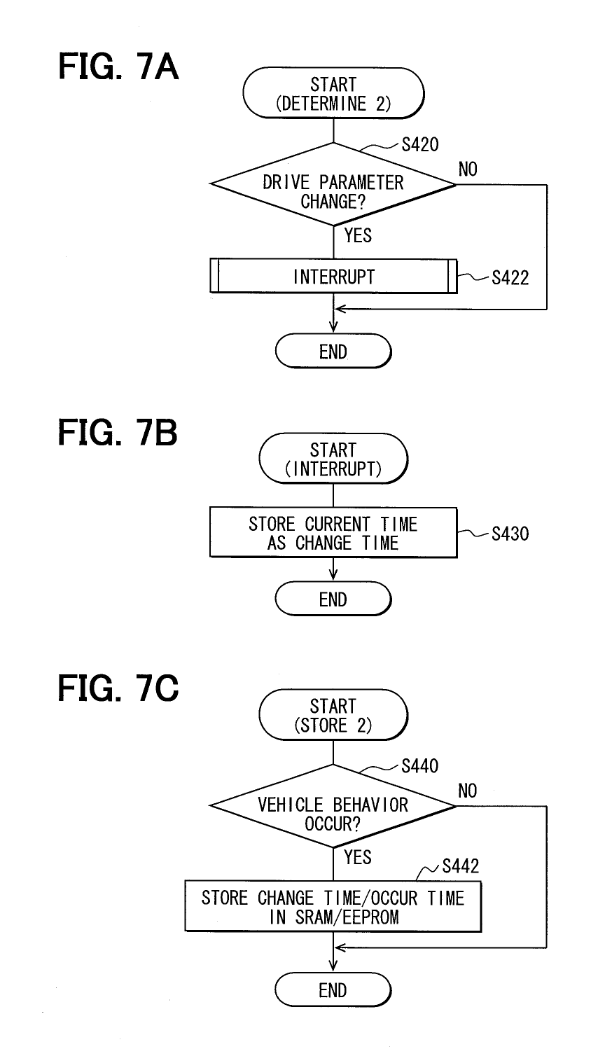

FIGS. 7A and 7C show flowcharts of a determination process 2 and storage process 2 respectively. In the determination process 2 of FIG. 7A, when the driving informational parameter has shown the predetermined change (S420: Yes), the ECU 20 calls, by a software interrupt, an interrupt process (S430 of FIG. 7B) to store the current time as a change time in a corresponding area of the RAM 26 to the driving informational parameter that has shown the predetermined change (S422).

Thus, in the determination process 2 to determine whether the driving informational parameter has shown the predetermined change, since a time at which the driving informational parameter has shown the predetermined change is stored as a change time, an offset between the actual time at which the driving informational parameter has shown the predetermined change and the stored change time is made as small as possible to store an accurate change time. Since the common process to store current times can be used by the interrupt process, the process to store current times temporarily in the RAM 26 in the storage process 2 is omitted to reduce the process load.

When the interrupt process of FIG. 7B is executed frequently, executions of the other interrupt processes may be prevented. Therefore, the interrupt process of FIG. 7B is desirably applied to the driving informational parameters having low change frequencies. On the other hand, when the driving informational parameters having high change frequencies have shown the predetermined changes, change times of these driving informational parameters are stored in the determination process 1 in FIG. 6A and storage process 1 shown in FIG. 6B.

In the storage process 2 shown in FIG. 7C, when the predetermined vehicle behavior occurs (S440: Yes), the ECU 20 stores, in the SRAM 28 or EEPROM 30, (i) the change time stored in the RAM 26 and (ii) an occurrence time of the predetermined vehicle behavior at the same time (S442).

In the determination process 2 of FIG. 7A and the storage process 2 of FIG. 7A, the process of S420 may correspond to the function executed by the change determination section, device, or means of the ECU 20 or CPU 22, processes of S430 and S442 may correspond to the function executed by the storage section, device, or means of the ECU 20 or CPU 22, and the process of S440 may correspond to the function executed by the behavior determination section, device, or means of the ECU 20 or CPU 22.

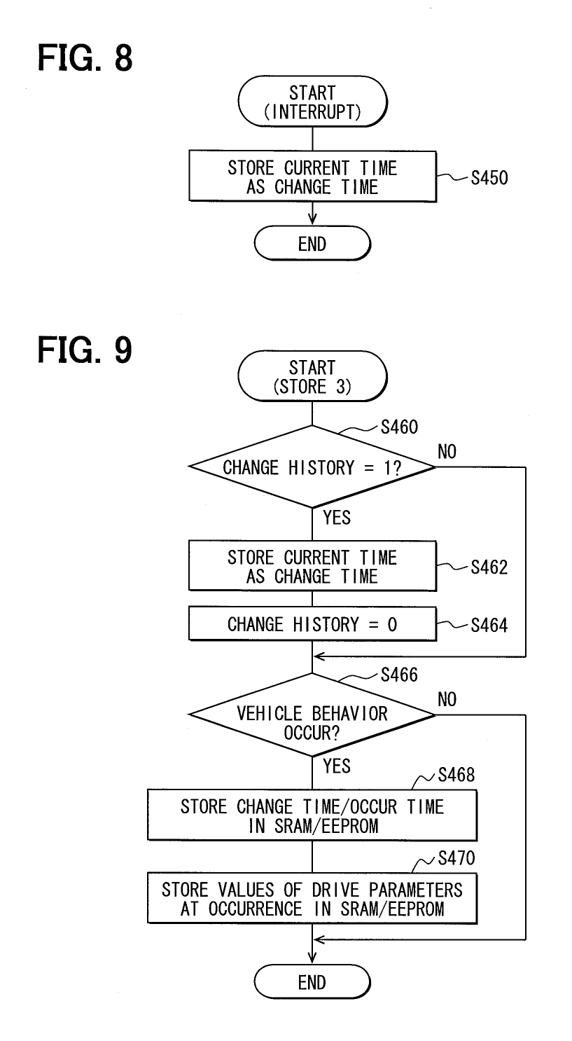

Instead of FIGS. 7A and 7B, a hardware interrupt process may be used. In the case where the ECU 20 inputs an analog signal as the driving informational parameter and AD-converts this signal therein to obtain ternary or more digital data, when a predetermined bit of each driving informational parameter becomes “1” in an AD converter, the driving informational parameter is determined to have shown the predetermined change, and then the hardware interrupt process of FIG. 8 is executed.

In the case where the ECU 20 inputs binary digital data of on and off as the driving informational parameter, when a rise or fall of the signal has been detected in an edge detection circuit, the driving informational parameter is determined to have shown the predetermined change, and then the hardware interrupt process of FIG. 8 is executed.

In the hardware interrupt process of FIG. 8, a current time is stored as a change time in the corresponding area of the RAM 26 to the driving informational parameter that has shown the predetermined change (S450). As in the storage process 2 of FIG. 7C, when the predetermined vehicle behavior occurs, the change time stored in the RAM 26 is stored along with the occurrence time of the predetermined vehicle behavior in the SRAM 28 or EEPROM 30.

In the hardware interrupt process of FIG. 8, since the change time at which the driving informational parameter has shown the predetermined change is stored by the hardware interrupt in which the driving informational parameter has shown the predetermined change, the time at which the driving informational parameter has shown the predetermined change can be stored accurately. Since whether the driving informational parameter has shown the predetermined change does not need to be determined by software, a process load of the software can be reduced.

In the determination process 2 of FIG. 7A and the storage process 2 of FIG. 7B, the process of S420 may correspond to the function executed by the change determination section, device, or means of the ECU 20 or CPU 22, the processes of S430 and S442 may correspond to the function executed by the storage section, device, or means of the ECU 20 or CPU 22, and the process of S440 may correspond to the function executed by the behavior determination section, device, or means of the ECU 20 or CPU 22.

In the hardware interrupt process of FIG. 8, the process of S450 may correspond to the function executed by the storage section, device, or means of the ECU 20 or CPU 22.

The change times and occurrence time stored in the processes of S430 of FIG. 7B, S442 of FIGS. 7C, and S450 of FIG. 8 may correspond to the analysis information.

(Storage Process 3)

A flowchart of a storage process 3 is shown in FIG. 9. The storage process 3 is executed instead of the storage process 1 shown in FIG. 6B.

In the storage process 3 of FIG. 9, when the predetermined vehicle behavior has occurred (S466: Yes), (i) the change time and (ii) an occurrence time of the predetermined vehicle behavior are stored simultaneously in the SRAM 28 or EEPROM 30 (S468), and additionally, all the driving informational parameters (i.e., values of all the driving informational parameters) when the predetermined vehicle behavior has occurred is stored in the SRAM 28 or EEPROM 30 (S470). This procedure is different from that of the storage process 1 of FIG. 6B.

In the storage process 3 of FIG. 9, all the driving informational parameters at the occurrence time when the predetermined vehicle behavior has occurred, in addition to the change time of the driving informational parameter and the occurrence time, is stored in the SRAM 28 or EEPROM 30 to obtain how the driving informational parameter changes from the predetermined change of the driving informational parameter to the occurrence of the predetermined vehicle behavior. On the other hand, the driving informational parameter whose change time has not been stored becomes a value at the occurrence time of the predetermined vehicle behavior without a predetermined change. Thereby, based on a change history of a value of each driving informational parameter, a cause of the predetermined vehicle behavior can be analyzed accurately.

In the storage process 3 of FIG. 9, the processes of S462, S468, and S470 may correspond to the function executed by the storage section of the ECU 20 or CPU 22, and the process of S466 may correspond to the function executed by the behavior determination section of the ECU 20 or CPU 22.

The change times, occurrence time, and driving informational parameter stored in the processes of S462, S468, and S470 may correspond to the analysis information.

(Determination Process Before and after Behavior)

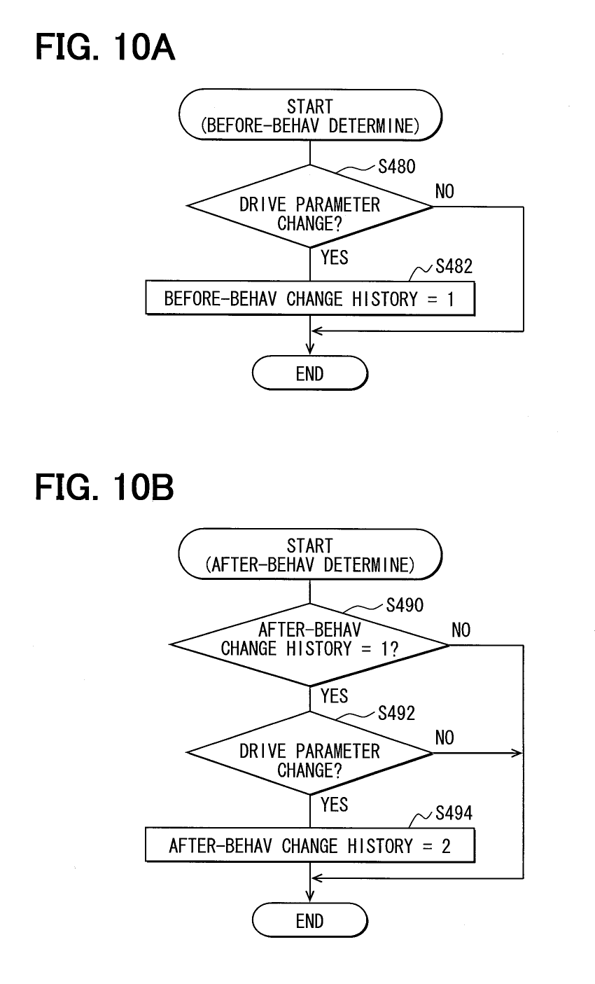

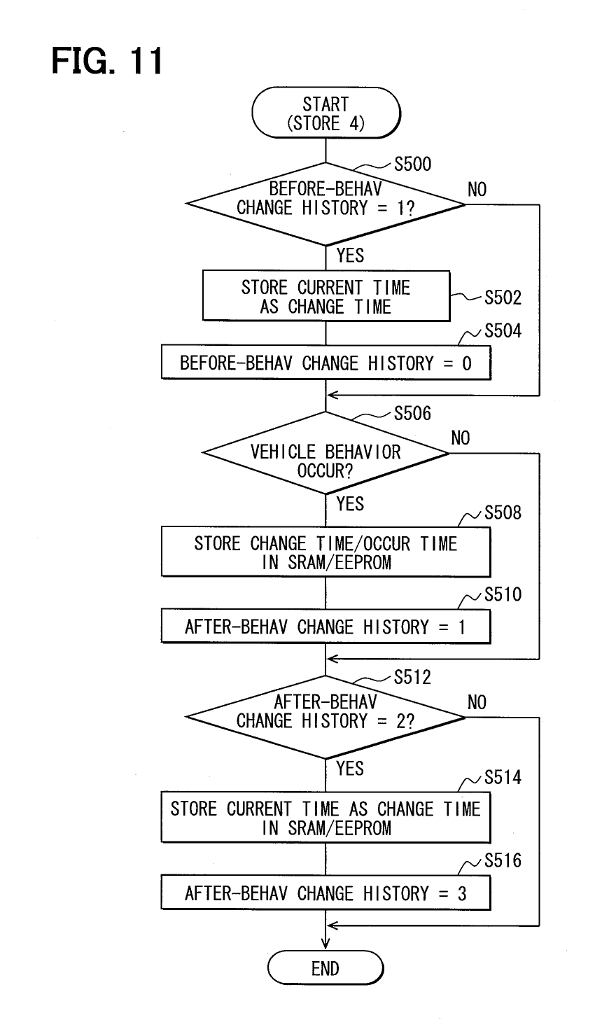

A flowchart of the determination process before the predetermined vehicle behavior is shown in FIG. 10A. A flowchart of the determination process after the predetermined vehicle behavior is shown in FIG. 10B. Based on determination results of the determination process before the vehicle behavior shown in FIG. 10A and the determination process after the vehicle behavior shown in FIG. 10B, the storage process 4 of FIG. 11 mentioned later is executed. In the determination process before the vehicle behavior in FIG. 10A, the determination process after the vehicle behavior in FIG. 10B, and the storage process 4 in FIG. 11, a change time after the predetermined vehicle behavior is stored in addition to a change time before the predetermined vehicle behavior.

In FIG. 10A, the ECU 20 determines whether one of multiple driving informational parameters has shown the predetermined change (S480). When any one of the driving informational parameters has shown the predetermined change (S480: Yes), 1 is set to a corresponding one of before-behavior change histories to the driving informational parameter that has shown the predetermined change (S482) as a variable that shows whether the driving informational parameter has shown the predetermined change. The before-behavior change histories are provided in the RAM 26 for respective driving informational parameters. When the before-behavior change history is 1, the corresponding driving informational parameter has shown the predetermined change before the predetermined vehicle behavior. An initial value of the before-behavior change history is 0.

In FIG. 10B, the ECU 20 determines whether an after-behavior change history provided in the RAM 26 for each driving informational parameter is 1 (S490). An initial value of the after-behavior change history is 0. When the after-behavior change history is 1, the change time stored in the RAM 26 before the predetermined vehicle behavior is stored in the SRAM 28 or EEPROM 30 at the occurrence of the predetermined vehicle behavior.

When the after-behavior change history is 1 (S490: Yes), the ECU 20 determines whether any one of the multiple driving informational parameters has shown the predetermined change after the predetermined vehicle behavior (S492). When any one of the multiple driving informational parameters has shown the predetermined change (S492: Yes), the ECU 20 sets 2 to the after-behavior change history (S494). When the after-behavior change history is 2, the corresponding driving informational parameter has shown the predetermined change after the predetermined behavior.

In the determination process before the behavior of FIG. 10A and the determination process after the behavior of FIG. 10B, the processes of S480 and S492 correspond to the function executed by the change determination section of the ECU 20 or CPU 22.

(Storage Process 4)

A flowchart of a determination process 4 is shown in FIG. 11.

At S500 of FIG. 11, the ECU 20 determines whether the before-behavior change history of any one of the driving informational parameters is 1 (S500). When the before-behavior change history is not 1 (S500: No), the ECU 20 determines that the driving informational parameter has shown no predetermined change between the previous storage process and current storage process, and then the flow proceeds to S506.

When the before-behavior change history is 1 (S500: Yes), the ECU 20 determines that any one of the driving informational parameters has shown the predetermined change between the previous storage process and current storage process. Then, the ECU 20 stores the current time as the change time in a corresponding one of the storage areas to the driving informational parameter that has shown the predetermined change, the storage areas being provided in the RAM 26 for respective driving informational parameters (S502). Then, the ECU 20 sets the before-behavior change history from 1 to 0 (S504).

At S506, the ECU 20 determines whether the predetermined vehicle behavior has occurred. When the predetermined vehicle behavior has occurred (S506: Yes), the ECU 20 stores, in the SRAM 28 or EEPROM 30, (i) the change time stored in the RAM 26 before the predetermined vehicle behavior and (ii) an occurrence time of the predetermined vehicle behavior, simultaneously (S508). When the driving informational parameter has shown no predetermined change, an initial value set in the RAM 26 as the change time is stored in the SRAM 28 or EEPROM 30.

Then, at S510, the ECU 20 sets the after-behavior change history to 1. As mentioned above, when the after-behavior change history is 1, the change time stored in the RAM 26 before the predetermined vehicle behavior is stored along with the occurrence time of the predetermined vehicle behavior in the SRAM 28 or EEPROM 30 at the occurrence of the predetermined vehicle behavior.

Next, the ECU 20 determines whether the after-behavior change history is 2 (S512). As mentioned above, when the after-behavior change history is 2, the corresponding driving informational parameter has shown the predetermined change after the predetermined vehicle behavior.

When the after-behavior change history is 2 (S512: Yes), the ECU 20 stores the current time in the area of the SRAM 28 or EEPROM 30, the area being set per each driving informational parameter, as the change time at which the driving informational parameter has shown the predetermined change after the predetermined vehicle behavior (S514). Then, the ECU 20 sets the after-behavior change history to 3 (S516).

Since the determination of S512 is “No” until the predetermined vehicle behavior occurs in the next time by setting the after-behavior change history to 3, the change time after the behavior is not stored. Next, since the after-behavior change history is set to 1 at S510 when the predetermined vehicle behavior occurs, the change time after the predetermined vehicle behavior is stored.

In the determination process before the behavior of FIG. 10A, the determination process after the behavior of FIG. 10B, and the storage process 4 of FIG. 11, the change time at which the driving informational parameter has shown the predetermined change before the predetermined vehicle behavior and the change time at which the driving informational parameter has shown the predetermined change after the predetermined vehicle behavior are stored. As a result, the change of the driving informational parameter before and after the predetermined vehicle behavior can be obtained. Thereby, a cause of the predetermined vehicle behavior can be analyzed accurately.

In the storage process 4 of FIG. 11, the processes of S502, S508, and S514 may correspond to the function executed by the storage section of the ECU 20 or CPU 22, and the process of S506 may correspond to the function executed by the behavior determination section of the ECU 20 or CPU 22.

The change times and occurrence time stored in the processes of S502, S508, and S514 may correspond to the analysis information.

(Storage Process 5)

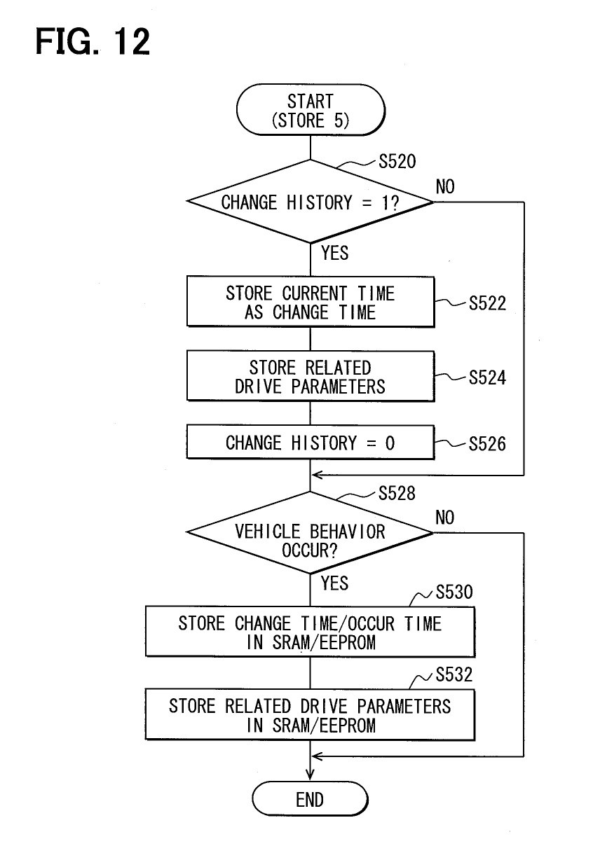

A flowchart of a storage process 5 is shown in FIG. 12. This storage process is executed instead of the storage process 1 shown in FIG. 6B. In the storage process of FIG. 12, the process explained below is added to the storage process 1 of FIG. 6B.

When the change history is 1 (S520: Yes), the current time is stored in the RAM 26 as a change time of the driving informational parameter that has shown the predetermined change, and additionally the driving informational parameter(s) (i.e., a value of the driving informational parameter(s)) related to the driving informational parameter that has shown the predetermined change is stored in the RAM 26 (S522, S524).

When the predetermined vehicle behavior has occurred (S528: Yes), (i) the change time stored in the RAM 26, (ii) an occurrence time of the predetermined vehicle behavior, and, additionally, (iii) the driving informational parameters (i.e., a value of the driving informational parameter(s)) related to the driving informational parameter that has shown the predetermined change are stored in the SRAM 28 or EEPROM 30 (S530, S532). As the driving informational parameters related to the driving informational parameter that has shown the predetermined change, the throttle opening, engine speed, vehicle speed, etc. are stored when the driving informational parameter that has shown the predetermined change is, for example, the accelerator opening.

On the other hand, the driving informational parameters stored at S524 may be, instead of the driving informational parameters related to the driving informational parameter that has shown the predetermined change, all the driving informational parameters (i.e., respective values of all the driving informational parameters) stored when the predetermined vehicle behavior has occurred.

According to the storage process 5 of FIG. 12, in addition to the change time when the driving informational parameter has shown the predetermined change and the occurrence time of the predetermined vehicle behavior, the driving informational parameters (i.e., values of the driving informational parameters) related to the driving informational parameter that has shown the predetermined change are stored. Therefore, based on the change time and its related driving informational parameters, a cause of the predetermined vehicle behavior can be analyzed accurately.

In the storage process 5 of FIG. 12, the processes of S522, S524, S530, and S532 may correspond to the function executed by the storage section of the ECU 20 or CPU 22, and the process of S528 may correspond to the function executed by the behavior determination section of the ECU 20 or CPU 22.

The occurrence time, change times, and driving informational parameters stored in the process of S522, S524, S530, and S532 may correspond to the analysis information.

(Output Process 1)

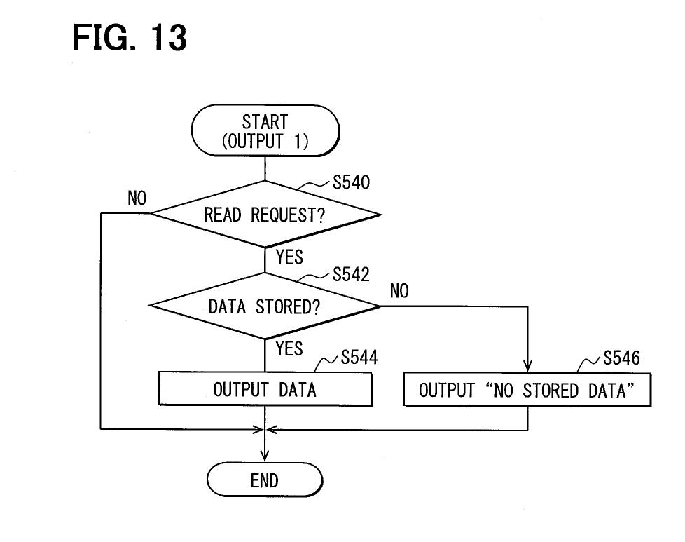

FIG. 13 shows a flowchart when the diagnostic tool 100 connected to a vehicle reads the occurrence time, the change times, and the driving informational parameters, if present, stored in the SRAM 28 or EEPROM 30 as the storage data or analysis information to output the storage data on a display etc.

When the diagnostic tool 100 receives a data read request by a manipulation of an operator etc. (S540: Yes), the diagnostic tool 100 determines whether the storage data is present in the SRAM 28 or EEPROM 30 (S542). This determination is made based on whether the stored data is an initial value.

When at least one of the stored data is not the initial value (S542: Yes), the diagnostic tool 100 outputs the stored data to a display etc. (S544). When the driving informational parameter at which the predetermined vehicle behavior has occurred (i.e., the value of the driving informational parameter at the occurrence time of the predetermined vehicle behavior) is stored, the change time, the occurrence time when the predetermined vehicle behavior has occurred, and the driving informational parameter at the occurrence time are outputted separately.

When all the stored data show initial values (S542: No), the diagnostic tool 100 outputs “no stored data” to a display etc. (S546). When all the stored data are initial values, no predetermined vehicle behavior has occurred or all the driving informational parameters whose change times are to be stored have shown no predetermined change even if the predetermined vehicle behavior occurred.

In the output process 1 of FIG. 13, the diagnostic tool 100 reads the occurrence time of the predetermine vehicle behavior, the change times at which the driving informational parameters have shown the predetermined changes, and the driving informational parameters, if present. These data have been stored in the vehicle. As a result, in a dealer etc., a cause of the predetermined vehicle behavior can be analyzed easily based on the output result.

In the output process 1 of FIG. 13, the process of S542 may correspond to the function executed by a read section of the diagnostic tool 100, and the process of S544 may correspond to the function executed by an output section of the diagnostic tool 100.

(Output Process 2)

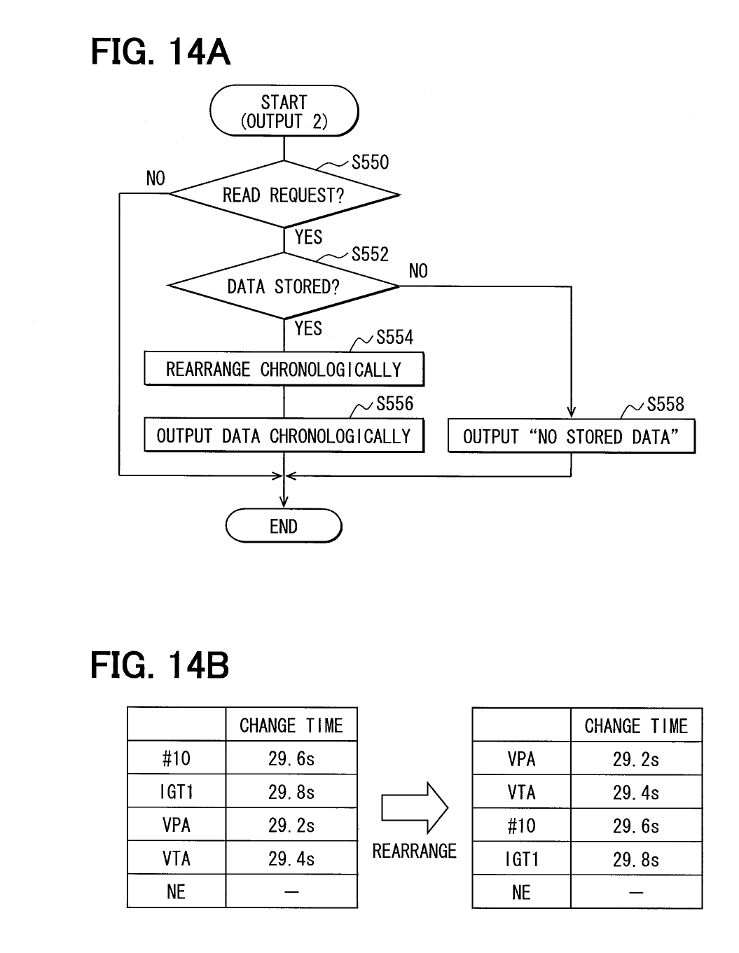

FIG. 14A shows a flowchart of an output process 2 by the diagnostic tool 100 connected to a vehicle.

In the output process 2 shown in FIG. 14A, the storage data read from the SRAM 28 or EEPROM 30 are rearranged in chronological order of the change times, as shown in FIG. 14B (S554). The rearranged stored data are outputted in chronological order (S556). This procedure is different from the output process 1 of FIG. 13. The other processes are the same as the output process 1 of FIG. 13.

In the output process 2 shown in FIG. 14A, the change times or the storage data including the change times and corresponding driving informational parameters are outputted based on the order of the change times at which the driving informational parameters have shown the predetermined changes, respectively. Therefore, an operator may not need to rearrange the storage data in chronological order.

In the output process shown in FIG. 14A, the processes of S552 and S554 may correspond to the function executed by the read section of the diagnostic tool 100, the process of S556 may correspond to the function executed by the output section of the diagnostic tool 100.

### Another Embodiment

In the present disclosure, the storage portion that stores the analysis information such as the occurrence time, the change times, and the driving informational parameters even when the drive of the vehicle is stopped is not limited to the SRAM 28 or EEPROM 30, and may be any storage portion capable of storing data even when the vehicle is stopped. The storage portion that stores the occurrence time, the change times, and driving informational parameters may be another storage portion mounted in its host ECU.

In the above embodiment, the change time of the driving informational parameter that has shown the predetermined change by the time (i.e., occurrence time) when the predetermined vehicle behavior occurs is temporarily stored in the RAM 26. The change time may be stored in the SRAM 28 or EEPROM 30 instead of the RAM 26.

The present disclosure may be applied to any of a vehicle having an internal combustion engine such as a gasoline engine and a diesel engine as a driving source, a hybrid vehicle having both an internal combustion engine and a motor, and an electrical vehicle having a motor as a driving source.

Aspects of the present disclosure described herein are set out in the following clauses.

According to a first aspect, an in-vehicle electronic apparatus is provided to store analysis information to analyze causes of predetermined vehicle behaviors. The apparatus includes a change determination section, a behavior determination section, and a storage section. The change determination section determines whether multiple driving informational parameters showing driving states of a vehicle indicate predetermined changes respectively. The behavior determination section determines whether a predetermined vehicle behavior occurs. The storage section stores, in a storage portion as analysis information, (i) an occurrence time of the predetermined vehicle behavior determined to occur by the behavior determination section, as well as (ii) a change time of the driving informational parameter determined to indicate the predetermined change by the change determination section by the occurrence time of the predetermined vehicle behavior. Herein, the occurrence time of the predetermined vehicle behavior is a time when the behavior determination section determines that the predetermined vehicle behavior occurs. The change time of the driving informational parameter is a time when the change determination section determines that a subject driving informational parameter indicates the predetermined change.

According to a second aspect being optional, the change determination section may determine that the driving informational parameter indicates the predetermined change when the driving informational parameter, which is binary data of on and off, switches between on and off or when the driving informational parameter, which is analog data or ternary or more digital data (i.e., multiple-valued digital data more than binary data), changes across a predetermined threshold.

According to this structure, it can be determined by software whether the driving informational parameter has shown the predetermined change without using a determination circuit. In this case, analog data is AD-converted to digital data, and then is determined. Thereby, the determination process can be changed easily by changing software, and the hardware quantity can be reduced.

According to a third aspect being optional, the change determination section may determine that the driving informational parameter indicates the predetermined change when the driving informational parameter, which is binary data of on and off, switches from on or off in one direction or when the driving informational parameter, which is analog data or ternary or more digital data (i.e., multiple-valued digital data more than binary data), crosses a predetermined threshold in one direction.

In this structure, since the change of the driving informational parameter is determined only by one-side change, the determination process can be simplified.

According to a fourth aspect being optional, the change determination section may determine that the driving informational parameter has shown the predetermined change when the driving informational parameter, which is binary data of on and off, does not change after the switch of on and off (i.e., switching between on and off) by one or more determinations or when a change amount of the driving informational parameter, which is analog data or ternary or more digital data (i.e., multiple-valued digital data more than binary data), exceeds a predetermined amount.

According to this structure, it is determined one or more times whether a value of the driving informational parameter, which is binary data of on and off, does not change after its switch between on and off. Even when it is determined that the driving informational parameter has shown the predetermined change after false determination of on or off due to noise, it can be determined that the driving informational parameter has shown no predetermined change unless a value becomes the same value after the change.

A change amount or difference of the driving informational parameter, which is ternary or more digital data, is obtained. Accordingly, noise contained in the driving informational parameter can be canceled and reduced.

According to a fifth aspect being optional, the determination process by the change determination section and the storage process of analysis information in a storage portion by the storage section may be executed by different processing programs respectively.

According to this structure, the time to execute the determination process can be further reduced than that in the case where the determination process and storage process are executed by the same program. Accordingly, the influence of the determination process on the overall process load is reduced and thus the time interval for the determination process can be reduced. As a result, it can be determined accurately whether the driving informational parameter has shown the predetermined change.

According to a sixth aspect being optional, when the change determination section determines that a subject driving informational parameter has shown the predetermined change, the storage section may store a change time of the subject driving informational parameter in a storage portion by an interruption process in the determination process of the change determination section.

According to this structure, since a change time is stored when any one of the driving informational parameters has shown the predetermined change, an offset between the time when any one of the driving informational parameters has shown the predetermined change and the stored change time is as small as possible to store an accurate change time.

Since the common process to store a current time can be used by use of the interruption process, the processing load to acquire the current time can be reduced.

According to a seventh aspect being optional, the change determination section may determine by hardware whether a subject driving informational parameter indicates the predetermined change. The storage section may store a change time of the subject driving informational parameter in the storage portion by hardware interrupt when the change determination section determines that the subject driving informational parameter indicates the predetermined change.

According to this structure, a change time is stored by hardware interrupt when any one of the driving informational parameters has shown the predetermined change. The offset between the time when any one of the driving informational parameters has shown the predetermined change and the stored change time is as small as possible to store an accurate change time.

Additionally, since it is unnecessary to determine whether any one of the driving informational parameters has changed by software, the processing load of software can be reduced.

According to an eighth aspect being optional, the storage section may further store, in the storage portion as the analysis information, an other driving informational parameter related to a subject driving informational parameter determined to indicate a predetermined change by the change determination section, to be associated with a change time when the subject driving informational parameter indicates the predetermined change.

According to this structure, since the driving informational parameter related to the driving informational parameter that has shown the predetermined change is stored together with the change time, a cause of the predetermined vehicle behavior can be analyzed accurately based on the change time and related driving informational parameter.

According to a ninth aspect being optional, the storage section may further store, in a storage portion as analysis information, in addition to (i) a change time of a subject driving informational parameter determined to indicate a predetermined change by the change determination section by an occurrence time when the behavior determination section determines that the predetermined vehicle behavior occurs, and (ii) the occurrence time of the predetermined vehicle behavior, values of driving informational parameters including the subject driving informational parameter at the occurrence time of the predetermined vehicle behavior.

According to this structure, how the driving informational parameter whose change time has been stored is changed after the storage of the change time can be obtained from a value of the driving informational parameter stored when the predetermined vehicle behavior has occurred. On the other hand, the driving informational parameter whose change time has not been stored becomes a value at the occurrence time of the predetermined vehicle behavior without a predetermined change. Thereby, based on a change history of a value of each driving informational parameter, a cause of the predetermined vehicle behavior can be analyzed accurately.

According to a tenth aspect being optional, when the change determination section may determine that a subject driving informational parameter indicates a predetermined change after the behavior determination section determines that the predetermined vehicle behavior occurs, the storage section may further store the change time of the subject driving informational parameter after the predetermined vehicle behavior occurs in the storage portion as the analysis information.

According to this structure, since a change state of the driving informational parameter before and after the predetermined vehicle behavior has occurred is obtained, a cause of the predetermined vehicle behavior can be analyzed accurately.

According to an eleventh aspect being optional, the storage section may store, in the storage portion as analysis information, only a change time of the driving informational parameter determined to indicate the predetermined change by the change determination section.

According to this structure, the storage amount stored when the driving informational parameter has shown the predetermined change can be reduced.

According to another example of the present disclosure, a diagnostic system is provided to include the in-vehicle electronic apparatus according to the above example and a diagnostic tool connected to the in-vehicle electronic apparatus. The tool includes: a read section to read analysis information stored in the storage portion; and an output section to output the analysis information read from the storage portion.

According to a thirteenth aspect being optional, when driving informational parameters that indicate predetermined changes are stored in the storage portion along with change times to which the driving informational parameters correspond, the output section may rearrange the change times in chronological order, and output the rearranged change times in the chronological order to be associated with the corresponding driving informational parameters.

According to this structure, it is not necessary for an operator who manipulates the diagnostic tool to rearrange the change times in chronological order when the corresponding driving informational parameters that have shown the predetermined changes are stored along with the change times. As a result, the work by the operator can be reduced.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. An in-vehicle electronic apparatus in a vehicle to store analysis information to analyze causes of predetermined vehicle behaviors,
the in-vehicle electronic apparatus comprising:
a change determination section that determines whether a plurality of driving informational parameters representing driving states of the vehicle indicate predetermined changes, respectively;
a behavior determination section that determines whether a predetermined vehicle behavior occurs; and
a storage section that stores, in a storage portion as analysis information, (i) an occurrence time of the predetermined vehicle behavior, which is determined to occur by the behavior determination section, as well as (ii) a change time of the driving informational parameter determined to indicate the predetermined change by the change determination section by the occurrence time of the predetermined vehicle behavior.

2. The in-vehicle electronic apparatus according to claim 1, wherein:
the change determination section determines that the driving informational parameter indicates the predetermined change
when the driving informational parameter, which is binary data of on and off, switches between on and off or
when the driving informational parameter, which is analog data or multiple-valued digital data more than binary data, changes across a predetermined threshold.

3. The in-vehicle electronic apparatus according to claim 2, wherein:
the change determination section determines that the driving informational parameter indicates the predetermined change
when the driving informational parameter, which is binary data of on and off, switches from one of on and off to an other in one direction or
when the driving informational parameter, which is analog data or multiple-valued digital data more than binary data, crosses a predetermined threshold in one direction.

4. The in-vehicle electronic apparatus according to claim 1, wherein:
the change determination section determines that the driving informational parameter indicates the predetermined change
when the driving informational parameter, which is binary data of on and off, does not change after switching between on and off by one or more determinations or
when a change amount of the driving informational parameter, which is analog data or multiple-valued digital data more than binary data, exceeds a predetermined amount.

5. The in-vehicle electronic apparatus according to claim 1, wherein:
a determination process by the change determination section and a storage process of the analysis information in the storage portion by the storage section are executed by different processing programs, respectively.

6. The in-vehicle electronic apparatus according to claim 1, wherein:
when the change determination section determines that a subject driving informational parameter indicates a predetermined change, the storage section stores a change time of the subject driving informational parameter in the storage portion using an interruption to interrupt a determination process by the change determination section.

7. The in-vehicle electronic apparatus according to claim 1, wherein:
the change determination section determines by hardware whether a subject driving informational parameter indicates a predetermined change; and
the storage section stores a change time of the subject driving informational parameter in the storage portion using an interruption by hardware when the change determination section determines that the subject driving informational parameter indicates the predetermined change.

8. The in-vehicle electronic apparatus according to claim 1, wherein:
the storage section further stores, in the storage portion as the analysis information, an other driving informational parameter related to a subject driving informational parameter determined to indicate a predetermined change by the change determination section, to be associated with a change time when the subject driving informational parameter indicates the predetermined change.

9. The in-vehicle electronic apparatus according to claim 1, wherein:
the storage section further stores, in a storage portion as analysis information, in addition to (i) a change time of a subject driving informational parameter determined to indicate a predetermined change by the change determination section by an occurrence time when the behavior determination section determines that the predetermined vehicle behavior occurs, and (ii) the occurrence time of the predetermined vehicle behavior, values of driving informational parameters including the subject driving informational parameter at the occurrence time of the predetermined vehicle behavior.

10. The in-vehicle electronic apparatus according to claim 1, wherein:
when the change determination section determines that a subject driving informational parameter indicates a predetermined change after the behavior determination section determines that the predetermined vehicle behavior occurs,
the storage section further stores a change time of the subject driving informational parameter after the predetermined vehicle behavior occurs in the storage portion as the analysis information.

11. The in-vehicle electronic apparatus according to claim 1, wherein:
the storage section stores, in the storage portion as the analysis information, only a change time of the driving informational parameter determined to indicate the predetermined change by the change determination section.

12. A diagnostic system, comprising:
the in-vehicle electronic apparatus according to claim 1; and
a diagnostic tool connected to the in-vehicle electronic apparatus,
the diagnostic tool including
a read section that reads analysis information stored in the storage portion of the in-vehicle electronic apparatus, and
an output section that outputs the analysis information read from the storage portion.

13. The diagnosis system according to claim 12, wherein:
when driving informational parameters that indicate predetermined changes are stored in the storage portion along with change times to which the driving informational parameters correspond,
the output section rearranges the change times in chronological order, and outputs the rearranged change times in the chronological order to be associated with the corresponding driving informational parameters.
